(19) United States
(12) Patent Application Publication
(10) Pub. No.: US 2022/0041264 A1
(43) Pub. Date: Feb. 10, 2022

(54) AIRCRAFT, AND THE PRODUCTION THEREOF

(71) Applicant: Dr. Ing. h.c. F. Porsche Aktiengesellschaft, Stuttgart (DE)

(72) Inventors: Patrick Scholl, Bietigheim-Bissingen (DE); Jens-Ole Thoebel, Hankensbuettel (DE); Christian Wenzel, Untergruppenbach (DE); Samantha Biedermann, Sachsenheim (DE)

(21) Appl. No.: 17/393,423

(22) Filed: Aug. 4, 2021

(30) Foreign Application Priority Data
Aug. 10, 2020 (DE) 10 2020 121 030.2

(51) Int. Cl. B64C 11/00; B64F 5/10

(52) U.S. Cl. CPC B64C 11/001; B64C 29/0016; B64F 5/10

(57) ABSTRACT

An aircraft includes wings with integrated ducted fans. The ducted fans each have a duct with cutouts and a guide grille fitted into the cutouts. The guide grilles can be adhesively bonded into the cutouts. The ducted fans can have different construction variants of the duct, wherein the cutouts have a corresponding shape across all construction variants.

### CROSS REFERENCE TO RELATED APPLICATIONS

This application claims benefit to German Patent Application No. DE 10 2020 121 030.2, filed on Aug. 10, 2020, which is hereby incorporated by reference herein.

### FIELD

The present disclosure relates to an aircraft, in particular a fully electric vertical take-off and landing (VTOL) aircraft, and to an advantageous method for producing such an aircraft.

### BACKGROUND

VTOL is the cross-language name given in the aerospace industry to any type of aircraft, drone or rocket that has the capability of lifting off and landing again substantially vertically and without a runway. This collective term is used below in a broad sense that includes not just fixed-wing aircraft with wings, but rather also rotary-wing aircraft such as helicopters, gyrocopters, gyrodynes and hybrids such as composite or combination helicopters and convertiplanes. Short take-off and landing (STOL) aircraft, short take-off and vertical landing (STOVL) aircraft and vertical take-off and horizontal landing (VTHL) aircraft are also included.

CN104691751A discloses a safe triangle-supported and lightweight multi-rotor aircraft with a tenon and mortise structure, which aircraft is composed of fuselage, rotors, a flight control module arranged in the center of the fuselage, and an integrated, wiring-harness-like connection line. The fuselage comprises a horizontal structure plate and a multiplicity of lightweight vertical structure plates, which are connected by means of tenons and mortises to form a triangular load-bearing structure, the outer side of which forms a frame and the inner side of which is supported at an opposite angle. The rotors are arranged at the outermost points of intersection of the vertical plates in a vertical direction, whereas the horizontal plate is connected to the vertical surface of the frame and is used for fastening. A multiplicity of circular rotor holes, which protect the rotors and the diameters of which are somewhat larger than those of the rotors, are formed in the horizontal plate by virtue of the rotor drive shaft being used as a circle central point. Finally, a multiplicity of tenons is arranged at the contact point of each vertical plate and the horizontal plate, which is correspondingly provided with mortises which are connected to the tenons.

### SUMMARY

In an embodiment, the present disclosure provides an aircraft. The aircraft includes wings with integrated ducted fans. The ducted fans each have a duct with cutouts and a guide grille fitted into the cutouts.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows the isometric view of a wing with partially transparent cladding and outer skin;

FIG. 2 shows the isometric view of the ducted fans of the wing without motor;

FIG. 3 shows a view, corresponding to FIG. 2, from an elevated perspective;

FIG. 4 shows the isometric view of a fan with partially transparent inlet and outlet;

FIG. 5 shows the front view of two duct parts in two different construction variants;

FIG. 6 shows the isometric view of a duct and guide grille in one of the variants as per FIG. 5;

FIG. 7 shows the fitted connection of the duct and guide grille in detail; and

FIG. 8 shows the isometric view of a duct and guide grille in the other variant as per FIG. 5.

### DETAILED DESCRIPTION

The present disclosure provides an aircraft, in particular a fully electric vertical take-off and landing aircraft in the above sense, and a method for producing such an aircraft.

The approach according to the present disclosure is based on the insight that a VTOL aircraft that can be used in urban environments requires drive units in different positions and orientations, which drive units are on the one hand capable of handling every phase of flight (take-off, transition, cruise and landing) but on the other hand do not exceed a manageable number of individual parts.

For the lift of the aircraft, it is the case here that, instead of an exposed rotor, ducted fans are provided which are integrated into the wing surface, such as are known, outside the aerospace sector, for example from hovercraft or swamp craft. The cylindrical housing of the air channel—hereinafter referred to as duct—reduces the shear losses that arise owing to turbulence at the blade tips of such a ducted fan.

According to the present disclosure, said duct is equipped with cutouts which allow it to be equipped in modular fashion—that is to say in accordance with a modular principle—with a guide grille (stator) which is optimized for the construction variant and direction of rotation of the respective propeller drive. The same concept can be used with further construction variants, such that ducts and specific guide grilles can be combined as desired in order to achieve cost savings.

Further advantageous configurations are described herein. For example, the guide grilles may be cohesively fitted into the cutouts, and in particular adhesively bonded therein. Through the use of such a universal “adhesive garage” on the housings, the specific stator variants can be produced inexpensively in various embodiments and used universally.

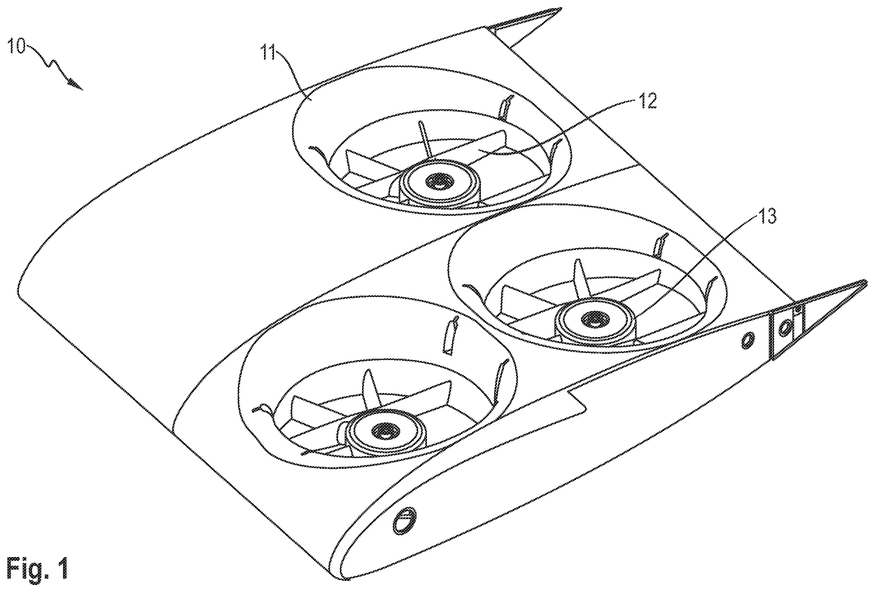

FIG. 1 illustrates the construction of a wing (10) for a selectively fully autonomously or manually controlled aircraft, which wing is divided approximately into quadrants by spars and ribs. In three of these quadrants, there is integrated in each case one ducted fan, the guide grille (12) of which, arranged within the duct (11), supports a central electric motor (13). For this purpose, the three cylindrical electric motors (13) are screwed radially to the respective guide grille (12) such that the struts thereof, manufactured from carbon-fiber-reinforced plastic (CFRP), are capable of supporting the electric motor (13) in an axially and rotationally symmetrical arrangement from opposite sides.

In the illustrated configuration, two of the struts of each guide grille (12) run parallel to one another in the incident-flow direction of the wing (10) and tangentially flank the associated electric motor (13). In each case two beams, joined to said webs, combine with the beams of the respective other web, which are situated diametrically oppositely in relation to the motor (13), to form a St Andrew's or diagonal cross and stiffen the electric motor (13) such that the guide grille (12) accommodates all horizontal forces in the plane of the motor. As is suggested in the figure, the struts of the guide grille (12) have, for this purpose, a width which corresponds approximately to the height of the electric motor (13).

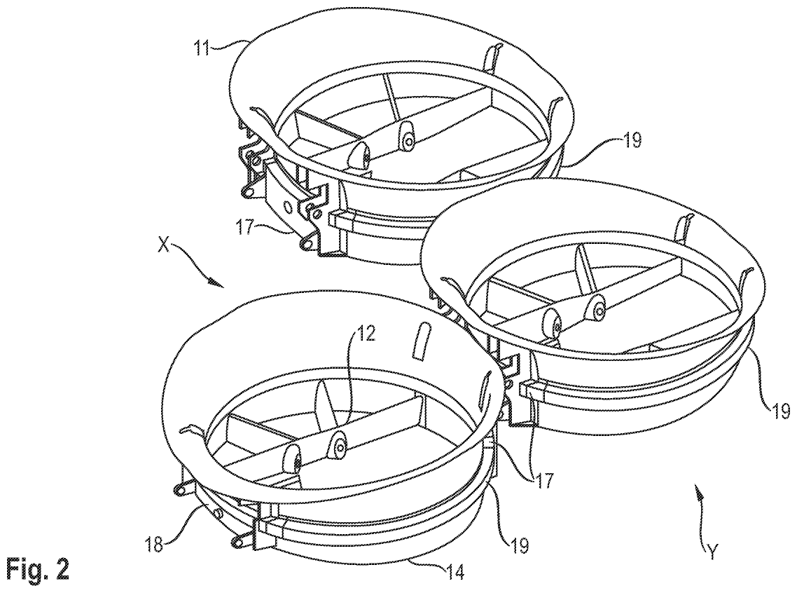

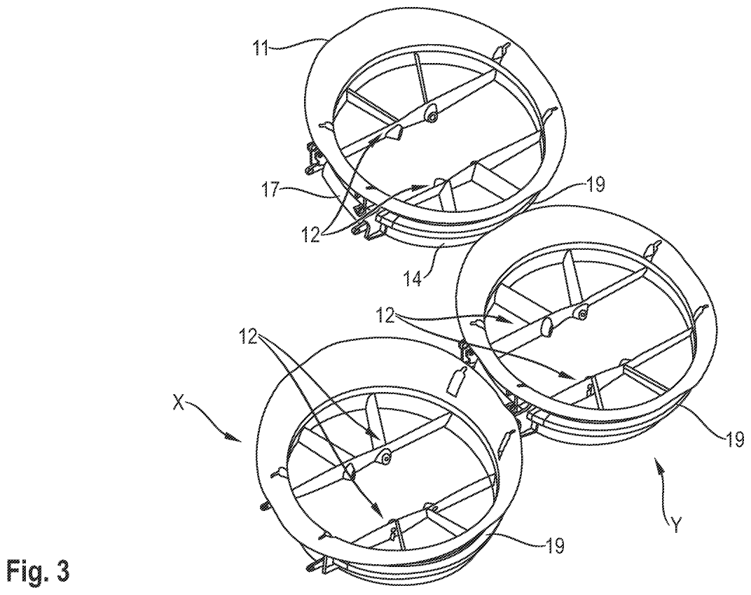

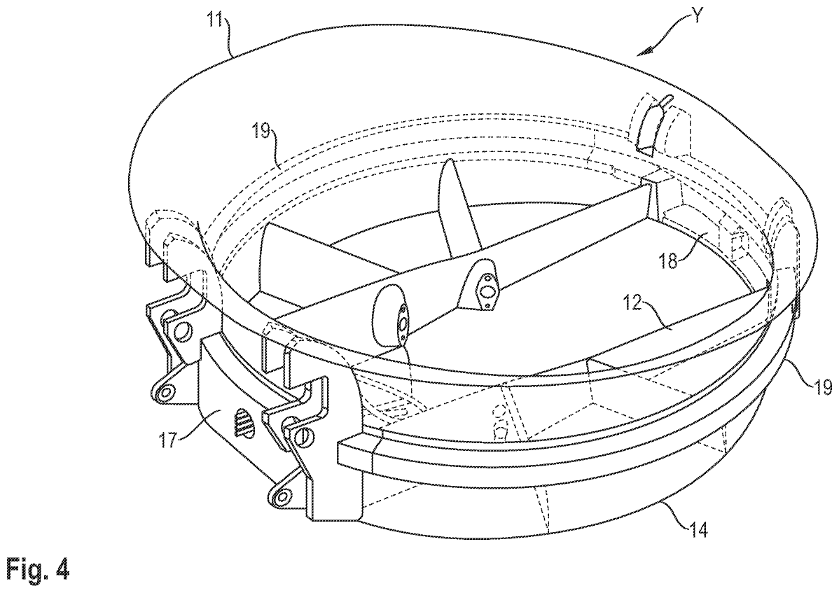

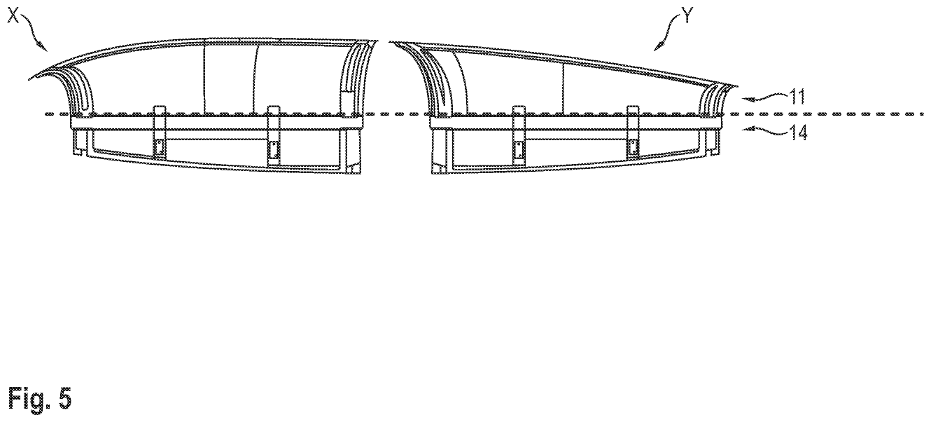

FIGS. 2 and 3 illustrate the different construction variants (X, Y) of the duct (11). This formation of variants is made possible by means of the modular system illustrated in FIG. 4 on the basis of the construction variant Y and in FIG. 5 by way of the comparison of the variants X and Y: The duct (in this case: 11, 14) is made up of inlet regions (11) and outlet regions (14), which are stiffened by means of an encircling ring (17, 18, 19—FIG. 4).

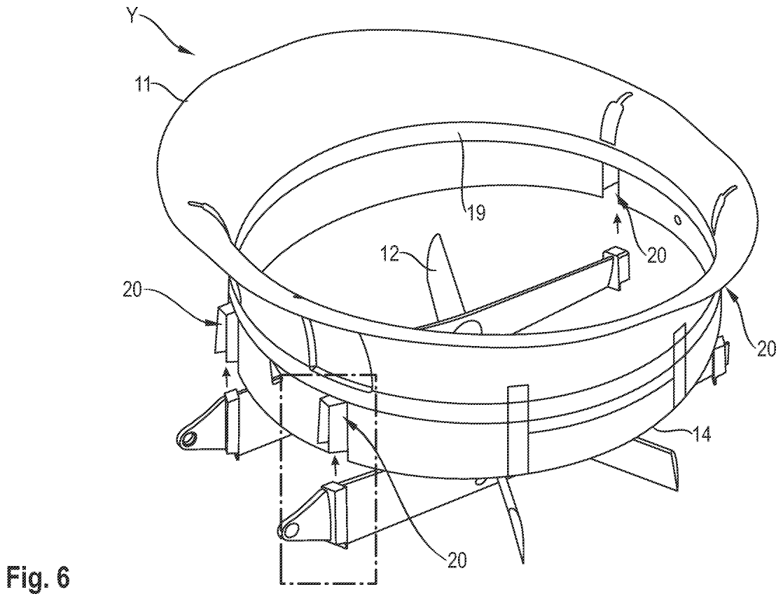

FIG. 6 directs the attention of the viewer, on the basis of an exemplary duct (in this case: 11, 14, 19) of construction variant Y, to the fitted connection of the guide grille (12). For this purpose, the outlet regions (14) of the duct (11, 14, 19) of the present embodiment have two pairs of in each case diametrically oppositely situated cutouts (20) into which, as per the figure, the associated guide grille (12) can be fitted from below.

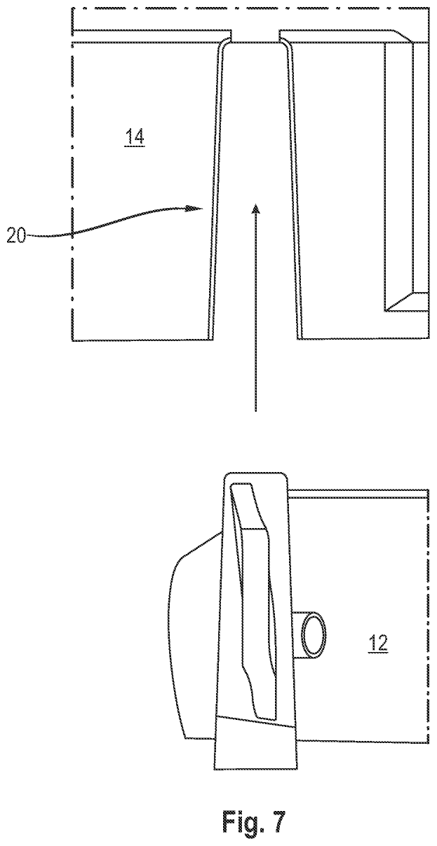

FIG. 7 illustrates this manufacturing step in a detail illustration. The cutout (20) shown has—as can be clearly seen in this view, approximately the shape of an isosceles trapezoid, the relatively long bottom side of which issues into the bottom edge, in the figure, of the outlet region (14). That strut of the guide grille (12) which is to be fitted into said cutout has a complementary shape which enables the grille (12) positioned below the outlet region (14) to be fitted together with the duct in an upward direction along the central axis of said duct and adhesively bonded into the cutouts (20) of said duct.

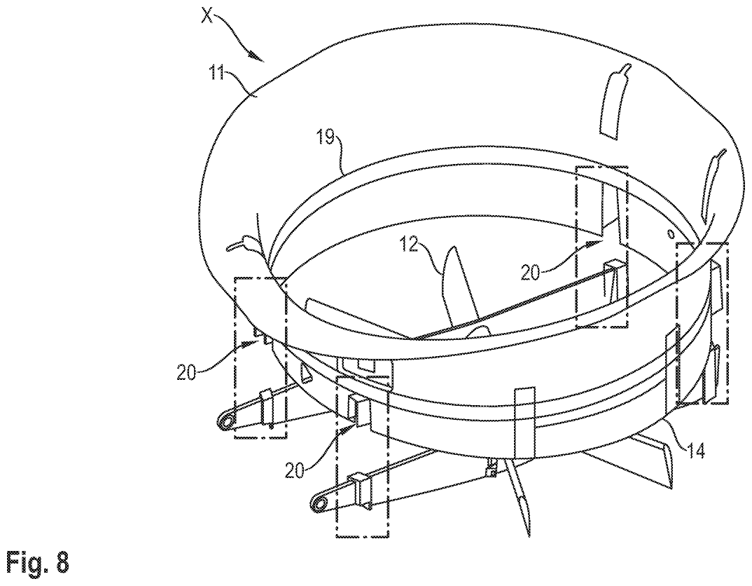

The advantage of this approach can be seen in a juxtaposition with FIG. 8: Owing to the trapezoidal shape of the cutouts (20) that corresponds across all construction variants (X, Y), a structurally identical guide grille (12) can be fitted into the outlet region (14) of a duct (11, 14, 19) of variant Y.

The individual ducts (11, 14) of the fans may for example be assembled from honeycomb cores with inserts, and thereupon preferably coated in multiple layers with CFRP. In the present context, this is to be understood to mean any composite material in which carbon fibers are embedded into a plastics matrix that serves for connecting the fibers and for filling the intermediate spaces. As a matrix, aside from conventional epoxy resin, use may also be made of other thermosets or thermoplastics.

In the present embodiment, the electric motor (13—FIG. 1) is designed as an air-cooled internal-rotor motor with integrated controller. It is self-evident that, in an alternative configuration, use may for example be made of an external-rotor motor or a liquid-type cooling arrangement. Further exemplary options are disclosed for example by DUFFY, Michael, et al. “Propulsion scaling methods in the era of electric flight” in: 2018 AIAA/IEEE Electric Aircraft Technologies Symposium (EATS). IEEE, 2018. pp. 1-23.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aircraft, comprising:
wings with integrated ducted fans,
wherein the ducted fans each have a duct with cutouts and a guide grille fitted into the cutouts.

2. The aircraft as claimed in claim 1, wherein the guide grilles are cohesively fitted into the cutouts.

3. The aircraft as claimed in claim 2, wherein the guide grilles are adhesively bonded into the cutouts.

4. The aircraft as claimed in claim 1, wherein the ducted fans have different construction variants of the duct, and
wherein the cutouts have a corresponding shape across all construction variants.

5. The aircraft as claimed in claim 4, wherein the corresponding shape of the cutouts is an isosceles trapezoid, and
wherein the cutouts are arranged pairwise at diametrically opposite positions of the duct.

6. The aircraft as claimed in claim 1, wherein the duct regions each have an encircling stiffness ring.

7. The aircraft as claimed in claim 6, wherein the ducts are in each case made up of inlet regions and outlet regions, and
wherein the outlet regions support the stiffness rings and have the cutouts.

8. The aircraft as claimed in claim 1, wherein the ducts have honeycomb cores with inserts, and
wherein the ducts are coated in multiple layers with carbon-fiber-reinforced plastic.

9. The aircraft as claimed in claim 1, wherein the ducted fans have an electric motor supported by the guide grille.

10. A method for producing an aircraft as claimed in claim 1, the method comprising:
fitting the guide grilles into the cutouts of the ducts, and
inserting the ducted fans into the wings in different installation positions.
